(19) United States
(12) Patent Application Publication
(10) Pub. No.: US 2014/0246376 A1
(43) Pub. Date: Sep. 4, 2014

(54) CONCENTRATION OF SUSPENSIONS

(71) Applicant: BASF SE, Ludwigshafen (DE)

(72) Inventors: Alexsandro Berger, Rosenheim (DE); Stephen Adkins, West Yorkshire (GB); Stephan Hess, Koeln (DE)

(73) Assignee: BASF SE, Ludwigshafen (DE)

(21) Appl. No.: 14/351,378

(22) PCT Filed: Oct. 24, 2012
(86) PCT No.: PCT/EP2012/071009

§ 371 Date: Apr. 11, 2014

Related U.S. Application Data
(60) Provisional application No. 61/550,938, filed on Oct. 25, 2011.

(30) Foreign Application Priority Data
Oct. 25, 2011 (EP) 11186439.3

(51) Int. Cl. C02F 1/54; C02F 1/72

(52) U.S. Cl. CPC C02F 1/54; C02F 1/722
USPC 210/721

(57) ABSTRACT

A process of concentrating a suspension of solid particles in an aqueous medium comprising introducing into the suspension at least one organic polymeric flocculant and addition of an agent system, in which the solid particles in the suspension are flocculated by the action of the at least one organic polymeric flocculant and the so formed flocculated solid particles settle to form a settled layer of solids suspended in the aqueous medium, wherein the agent system comprises: i) at least one oxidising agent; ii) at least one control agent,

The present invention relates to an improved thickening process in which an aqueous suspensions of solids are flocculated and settled to form a more concentrated suspension. The improvement of the invention concerns a new agent system which provides improved control of the rheology and/or yield stress and/or solids content of the more concentrated suspension.

It is known to concentrate suspensions of solids in aqueous liquids by the use of flocculants resulting in flocculation of the solids which facilitates the separation of solids from the liquid. In many processes the flocculated solids settle to form a bed by sedimentation. In other processes separation can be facilitated by mechanical dewatering or mechanical thickening, for instance in pressure filtration, centrifugation, belt thickeners and belt presses.

The types of flocculants added to the suspension will often depend upon the substrate. Generally suspensions tend to be flocculated by high molecular weight polymers. Examples of this are described in WO-A-931 852 and U.S. Pat. No. 3,975,496 which are concerned with the flocculation of mineral suspensions such as red mud. Other disclosures of high molecular weight polymeric flocculants include U.S. Pat. No. 6,447,687, WO-A-0216495 and WO-A-02083258 dealing with the flocculation of sewage sludge. It is also known to sometimes add other chemical additives in order to condition the suspension. For instance, suspensions may be first coagulated by a high charge density polymeric coagulant such as polyDADMAC or inorganic coagulants including ferric chloride.

Other additives are also used in the conditioning of suspensions. For instance peroxides are sometimes added to suspensions such as sewage sludges or other suspensions containing organic material in order to remove reducing agents and also to reduce odours, gas formation or prevent putrefaction. In general the peroxides or oxidising agents can be added in order to remove harmful or unwanted substances or other materials contained in the suspension. Generally the amount of peroxides or other oxidising agents added would be only sufficient to remove the unwanted substances and materials and generally peroxides or other oxidising agents are included in relatively small amounts such that none or very little of the peroxides or other oxidising agents will remain.

Examples of adding peroxides to sewage sludge are described in JP56150481. Peroxides or oxidising agents may also be added to other suspensions for similar reasons including treating dredged material to remove contaminants as described in US 2003 121863 and JP 10109100. JP 11156397 describes a process for flocculating mud using non-ionic and anionic polymers in which the mud has been pretreated with an oxidising agent. U.S. Pat. No. 6,733,674 describes a method of dewatering sludge by adding an effective amount of one or more cellulolytic enzymes and one or more oxidants and one or more flocculants to form a mixture in water which is coagulated and flocculated followed by separation of solids from the water. The examples seem to indicate a significant time elapsed between oxidant addition and flocculation. The enzymes appeared to be present in order to degrade material contained in the sludge.

Suspensions are frequently concentrated in a gravity thickener vessel. A continual flow of the suspension is typically fed into the thickener and treated with a flocculant. The flocculated solids thus formed settle to form a bed of solid underflow and supernatant aqueous liquid flows upwards and is usually removed from the thickener vessel through a perimeter trough at the water surface. Normally the thickener vessel has a conical base such that the underflow can easily be removed from the centre of the base. In addition a rotating rake assists the removal of the underflow solids. A typical process for concentrating suspensions in a gravity thickener is described in U.S. Pat. No. 4,226,714.

Various suspensions can be concentrated in gravity thickeners, including suspensions of organic solids such as wastewater, sewage and sewage sludges. It is also commonplace to thicken or dewater mineral suspensions using gravity thickeners.

In a typical mineral processing operation, waste solids are separated from solids that contain mineral values in an aqueous process. The aqueous suspension of waste solids often contains clays and other minerals, and is usually referred to as tailings. These solids are often concentrated by a flocculation process in a thickener and settle to form a bed. Generally it is desirable to remove as much water from the solids or bed in order to give a higher density underflow and to recover a maximum of the process water. It is usual to pump the underflow to a surface holding area, often referred to as a tailings pit or dam, or alternatively the underflow may be mechanically dewatered further by, for example, vacuum filtration, pressure filtration or centrifugation.

U.S. Pat. No. 5,685,900 describes a selective flocculation process for beneficiating a low brightness fine particle size kaolin in order to reduce a higher brightness kaolin clay. The process involves a classification step to recover the kaolin fraction wherein the particles are at least 90% by weight below 0.5 μm. The recovered fraction is then subjected to a bleaching step to partially bleach organic discolorants. The resulting slurry is selectively flocculated using a high molecular weight anionic polyacrylamide or acrylate acrylamide copolymer. This flocculation step forms a supernatant phase which is highly concentrated with contaminant titania and a flocculated clay phase which is devoid of titania that contains the discolorants. The flocs are then treated with gaseous ozone in order to oxidising the remaining discolouring organics and also destroy the flocculant polymer in order to restore the kaolin to a dispersed state. This is said to be achieved by passing the flocculated solids through an ozonation step, preferably using a high shear pump.

Similar disclosures are made in WO 2004 071 989 and US 2006 0131243.

WO 2005 021129 discloses controlling the condition of a suspension of solid particles within a liquid including applying 1 or more stimuli to the suspension. In this disclosure conditioning is preferably reversible and involves flocculation and/or coagulation in which inter particle forces may be attractive or repulsive between the solid particles within the liquid. The stimulus may be one or more chemical additives and may for instance be a stimulus sensitive polyelectrolyte which can be absorbed on the surface of the suspended particles in sufficient quantity to create steric or electrostatic repulsion between the particles. In one instance a polyelectrolyte may be substantially insoluble at pH values where it is substantially uncharged thereby to effect flocculation of the suspension. Polyelectrolytes that are responsive to a temperature stimulus are also described. Reference is also given to a method of controlling the consolidation of a bed of solid particles within a liquid by applying one or more stimuli to the bed. Each stimulus effects reversibly operable conditioning between an initial state, prevailing prior to said conditioning, applying one or more stimuli and a conditioned state resultant from said one or more stimuli. The processes described bring about improvements in certain solids liquids separation activities.

JP 11-46541 describes a temperature sensitive hydrophilic polymer added to a suspension of particles below a transition temperature whereupon flocs are formed by absorbing and cross-linking particles as a conventional flocculant. The mixture is heated to above the transition temperature and the absorbed polymer becomes hydrophobic and the suspended particles are rendered hydrophobic and form flocs by hydrophobic interaction. Appropriate external pressure is applied at this time and the particles are readily realigned and water between the particles is expelled by the hydrophobicity of the particles.

JP 2001 232104 describes a process similar to JP 11-46541 but using improved temperature sensitive flocculants that are ionic temperature sensitive polymer as opposed to non-ionic polymers which a absorb onto suspended particles and when the polymer becomes hydrophobic at temperatures above the transition point there are strong hydrate layers around the ionic groups but hydrated layer adhesion between the polymers is prevented by hydrophobic interaction.

Bertini, V. et. al. Particulate Science and Technology (1991), 9(3-4), 191-9 describes the use of multifunctional polymers for the pH controlled flocculation of titanium minerals. The polymers are radical vinyl copolymers containing catechol functions and acrylic acid units. The polymers can change their effect from flocculating to dispersing or inert and vice versa by changing pH.

The pH or temperature sensitive flocculants in principle provide control over the flocculation state of a suspension. However, the choice of flocculant would need to be appropriate for the particular suspension or bed that is to be flocculated and at the same time be responsive to a particular stimulus to bring about the reversibly operable conditioning. In some cases it may be difficult to find the right choice of flocculant.

Frequently some water will be trapped in the flocculated solids and this water is often difficult to release and therefore held in the bed. Whilst pH and temperature responsive flocculants may assist with this problem it is often difficult to achieve satisfactory flocculation across a wide range of substrates.

In processes involving gravity thickeners it is desirable to operate such that the bed has the highest possible solids capable of being removed from the thickener as an underflow. Normally the limiting factor is the ability of the rake in the thickener to move the sedimented solids. It would therefore be desirable to provide a process which increases the rate of separation of the solids from the suspension and removal of the underflow.

WO 2007 082797 describes a process of concentrating an aqueous suspension of solid particles by addition of organic polymeric flocculant to the suspension in order to form flocculated solids. The flocculated solids settle to become a more concentrated suspension. An agent selected from any of free radical agents, oxidising agents, enzymes and radiation is applied to the suspension prior to or substantially simultaneously with adding the organic polymeric flocculant and/or the organic polymeric flocculant and the agents are both added to the suspension in the same vessel. The process brings about a significant reduction in yield stress of the concentrated suspension or allows a significant increase in the solids content of the concentrated suspension for a given yield stress.

However, despite the huge benefits that this process has achieved it has been found that in certain cases the layer of solids in the more concentrated suspension may not always achieve the desired reduction in yield stress for a given solids content or desired increase in solids for a given yield stress.

It is an objective of the present invention to further improve upon this process.

The present invention relates to a process of concentrating a suspension of solid particles in an aqueous medium comprising introducing into the suspension at least one organic polymeric flocculant and addition of an agent system, in which the solid particles in the suspension are flocculated by the action of the at least one organic polymeric flocculant and the so formed flocculated solid particles settle to form a settled layer of solids in the aqueous medium,

wherein the agent system comprises:
i) at least one oxidising agent;
ii) at least one control agent,
   in which the at least one control agent consists of iia) at least one activator component and/or iib) at least one suppressor component, in which the at least one activator component increases the activity of the oxidising agent and the suppressor component decreases the concentration of the activator component,
   wherein
1) the at least one oxidising agent is added to the suspension before the flocculated solid particles have settled at a dose below that which will impair the settling rate and the at least one activator component is added into the settled layer of solids; or
2) the at least one activator component is added to the suspension before the flocculated solid particles have settled and the at least one oxidising agent is added into the settled layer of solids; or
3) the at least one oxidising agent is added to the suspension before the flocculated solid particles have settled at a dose below that which will impair the settling rate; the at least one activator component is present in suspension at a concentration (C2) which will not increase the activity of the oxidising agent and which concentration (C2) is above the effective concentration or range of concentrations (C1) that would increase the activity of the oxidising agent; and the at least one suppressor component is added into the settled layer of solids at a dose sufficient to reduce the concentration of the activator component to the effective concentration or within the range of concentrations (C1); or
4) the at least one activator component is present in suspension at a concentration (C2) which will not increase the activity of the oxidising agent and which concentration (C2) is above the effective concentration or range of concentrations (C1) that would increase the activity of the oxidising agent; and the at least one suppressor component is added to the suspension before the flocculated solid particles have settled at a dose sufficient to reduce the concentration of the activator component to the effective concentration or within the range of concentrations (C1); and the at least one oxidising agent is added.

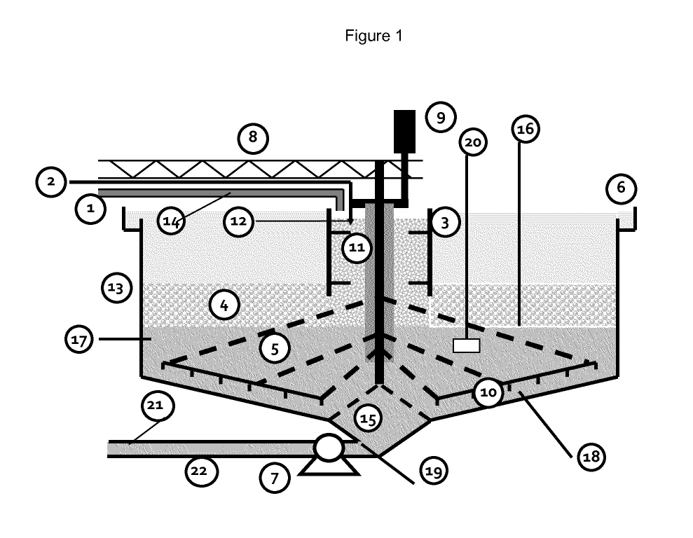

In FIG. 1 the diagram represents a standard gravimetric thickener vessel comprising the following components: slurry feed pipe (1) which conveys the suspension (14) into the feedwell (3) of the vessel (13); and organic polymeric flocculant (12) is added through flocculant feed line (2); the feedwell (3) is indicated as being a baffled feedwell; a high concentration of settling flocculated solids (11) is shown in the baffled feedwell; clarification zone (4) is indicated where the flocculated solids are settling and becoming separated from aqueous fluid; above the layer indicated as the clarification zone a layer is indicated showing a reduced concentration of settling flocculated solids; above this layer of a reduced concentration of flocculated solids an essentially low solids aqueous fluid is shown which flows over the overflow launder (6); below the clarification zone (4) a consolidated bed of solids (5), which forms the settled layer of solids (15) which forms the consolidated bed, is indicated at the lower end of the vessel; the consolidated bed of solids forms an underflow (21) which is fed from the vessel through a conduit (22) at the base of the vessel; an underflow pump (7) is present to assist the removal of the underflow from the vessel; a bridge (8) is present to allow access to the feedwell and rakes (10) and the rake drive mechanism (9). The oxidising agent or control agent may be introduced through one or more conduits (16) entering through the top of the vessel; or through one or more apertures or conduits (17) in the side walls of the vessel; or one or more apertures or conduits (18) in the base of the vessel; or one or more apertures or conduits (19) in the feed line conveying the bed of consolidated solids from the base of the vessel, for instance between the base of the vessel and a pump; or through one or more sparges (20).

The invention has been found to provide a more effective process and/or more efficient use of the oxidising agent. Furthermore, the invention has been found to provide a more convenient control of the rheology of consolidating material during the process of concentrating the aqueous suspension. This improvement is believed to be as a result of the applied agent system implementing both the addition of oxidising agent and also the application of the control agent.

Without being limited to theory it is believed that the heterogeneous nature of the chemical environment in the aqueous suspensions could interfere with the effect of the oxidising agent. In some cases this may lead to a reduction in the oxidising effect, thereby reducing the disaggregation of the flocculated network in the layer of the more concentrated suspension, or in other cases an acceleration of the oxidising power, which may lead to inadequate formation of the flocculated network. The inventors have found that by using the inventive agent system employing a combination of an oxidising agent and a control agent a more quantitative and qualitative control of the action of the agents can be achieved.

It would appear that the action of the oxidising agent on the flocculated solids gives rise to the concentrated aqueous suspension which can for instance be a bed of consolidated solids which would seem to have an altered state by comparison to the bed of consolidated solids that had not been so treated by the agent system. It would appear that the chemical interaction between the flocculant and the solids may be permanently altered as a result of the action of the agent system. It would also appear that the flocculated structure may be diminished or collapsed to such an extent that the solids occupy a smaller volume. We also find that this is a more concentrated aqueous suspension which is formed by the action of the agent may have improved flow characteristics. It is apparent that the yield stress of this more concentrated aqueous suspension may be significantly reduced for a given solids content. Furthermore, it is possible to increase the solids content for any given yield stress value.

Suitably the oxidising agent may be selected from perchlorates, hypochlorites, perbromates, hypobromites, periodates, hypoiodites, perborates, percarbonates, persulphates, peracetates, ozone and peroxides. The use of peroxides, ozone, hypochlorites, peracetates, perborates, percarbonate and persulphates have been found to be particularly effective for oxidizing purposes.

Preferred oxidising agents for use in present invention are peroxides and ozone. A particular preferred peroxide is hydrogen peroxide. Suitably the hydrogen peroxide will be in an aqueous solution containing at least 1% hydrogen peroxide on weight basis, typically at least 5% and often at least 10% and often at least 20%, preferably at least 30% as much as 50 or 60% or more. When ozone is used it is preferred that this is in the form of ozone water. Typically the ozone water would have a concentration of at least 0.1 ppm and usually at least 1 ppm. The concentration may be as much as 1000 ppm but usually effective results are obtained at lower concentrations, such as up to 500 ppm or even up to 100 ppm. Often the concentration will be in the range of between 5 ppm and 50 ppm, for instance between 10 ppm and 40 ppm, especially between 20 ppm and 30 ppm.

The amount of at least one oxidising agent will vary according to the specific process conditions, the type of substrate and flocculant. The oxidising agent preferably should be introduced at a dose in an amount of at least 1 ppm based on weight of agent on volume of the aqueous suspension. The oxidising agent can be effective at low levels for example between 1 and 10 ppm. Generally the agent will be added in an amount of from at least 100 ppm and in some cases may be at least 1000 ppm based on the volume of the first suspension. In some cases it may be desirable to add significantly higher levels of the oxidising agent, for instance as much as 40,000 or 50,000 ppm or higher. Effective doses usually will be in the range between 150 and 20,000 ppm, especially between 1000 and 15,000 ppm.

When the control agent comprises at least one activator component, the activator component may be any entity which increases the activity of the oxidising agent. The activator component within the scope of the present invention also includes materials which are either precursors to or can be converted into materials which increase the activity of the oxidising agent. Typically the activator component may interact with the oxidising agent to form oxidising radicals. Suitably the formation of these oxidising radicals will be at a faster rate and/or provide an increased concentration of oxidising radicals than the oxidising agent would have formed had the activator component not been added.

Typical doses of activator component may range from 0.1 ppm based on weight of activator on volume of aqueous suspension of solids. Preferably the activator component should be introduced at a dose in an amount of at least 1 ppm or at least 10 ppm. The activator component can be effective at low levels for example between 1 and 10 ppm. Alternatively, the activator component suitably can be effective at levels for example between 10 and 100 ppm. In other cases the activator component can be added in an amount of from at least 100 ppm and in some cases may be at least 1000 ppm based on the volume of the aqueous suspension. In some cases it may be desirable to add significantly higher levels of the activator component, for instance as much as 40,000 or 50,000 ppm or higher. Effective doses usually will be in the range between 150 and 20,000 ppm, especially between 1000 and 15,000 ppm.

Preferably the activator component of the at least one control agent is selected from the group consisting of iron (II) ions (Fe2+) (ferrous ions), iron (III) ions (Fe3+) (ferric ions), iron (IV) ions (Fe4+) (ferryl ions) and copper (II) ions (Cu2+) (cupric ions). Typically the iron (II), iron (III), iron (IV) or copper (II) ions may be employed in the form of suitable salts of the respective ions. Such salts may for instance be iron (II) sulphate, iron (II) nitrate, iron (II) phosphate, iron (II) chloride, iron (III) sulphate, iron (III) nitrate, iron (III) phosphate, iron (III) chloride, iron (IV) sulphate, iron (IV) nitrate, iron (IV) phosphate, iron (IV) chloride, copper (II) sulphate, copper (II) nitrate, copper (II) phosphate, copper (II) chloride. The respective ions tend to interact with the oxidising agent to more rapidly generate suitable reactive radicals thereby accelerating the effect of the oxidising agent. For instance iron (II) ions and copper (II) ions tend to interact with peroxides to promote the rapid formation of the hydroperoxyl radical (.OOH) and hydroxyl radical (.OH) which is an extremely powerful oxidising agent.

It may be desirable to use a combination of different activator components all one or a combination of compounds which liberate suitable activator components. For instance a compound in a high oxidation state may be used in combination with copper (I) containing compounds to generate copper (II) compounds. For instance, ferric chloride may be used in combination with copper (I) chloride thereby generating ferrous chloride and cupric chloride. Such compounds which may be precursors to activator components or which may be converted into activator components are also to be regarded as activator components within the meaning of the present invention.

When the at least one control agent comprises at least one suppressor component, the suppressor component may be any material or other entity which reduces the concentration of the at least one activator component. Suitably the suppressor component may include material selected from at least one of the group consisting of:
a) radical quencher,
b) sequestering agent; and
c) metal salts that promote the formation of side and deactivated (complexes) species.

Radical quenchers tend to be chemical compounds which remove radicals from the environment in which they exist. Suitably the radical quenchers include compounds, such as sodium bisulphite. Radical quenchers tend to reduce the amount of free radicals for instance of the activator component and thereby reducing the effect of the activator component.

Sequestering agents may include any compound which is capable of chelating or sequestering the activated components, for instance metal ions. Suitable sequestering agents include EDTA (ethylenediamine tetra acetic acid or salts thereof, for instance the tetra sodium salt); ethylenediamine; DTPA (diethylene triamine pentaacetic acid or salts thereof, for instance the penta sodium salt); HEDPA (hydroxyethylidene diphosphonic acids or salts thereof, for instance the tetra sodium salt); NIL (nitrilotriacetic acid or salts thereof, for instance the tri sodium salt); ATMP (amino trimethylene phosphonic acid or salts thereof, for instance the hexa sodium salt); EDTMPA (ethylene diamine tetra methylene phosphonic acid or salts thereof, for instance the octa sodium salt); DTPMPA (diethylene triamine penta methylene phosphonic acid or salts thereof, for instance the deca sodium salt); PBTCA (2-phosphonobutane-1,2,4-tricarboxylic acid or salts thereof, for instance the penta sodium salt); polyhydric alcohol phosphate ester; 2-hydroxy phosphono carboxylic acid or salts thereof, for instance the di sodium salt; and BHMTPMPA (Bis(hexamethylene triamine penta(methylene phosphonic acid)) or salts thereof, for instance the deca sodium salt).

Metal salts that promote the formation of side and deactivated (complexes) species salts of magnesium (II) and manganese (II).

Metal salts such as salts of magnesium (II) and manganese (II) include for instance magnesium (II) sulphate, magnesium (II) nitrate, magnesium (II) phosphate, magnesium (II) chloride, manganese (II) sulphate, manganese (II) nitrate, manganese (II) phosphate, manganese (II) chloride. These compounds serve to reduce the oxidising power of the oxidising agent.

WO2011/125047 discloses methods in which the agents can be introduced into the suspension.

The agent system according to the present invention may be introduced in analogous way to any of the means of introduction disclosed in this application.

In accordance with the present invention defined according to claim 1 the means with which the at least one oxidising agent and at least one control agent are introduced respectively into the bed of consolidated solids or the flocculated solids that are settling may include one or a multiplicity of apertures in the side walls of the vessel to which the agent can be introduced. Instead of or as well as apertures in the side walls of the vessel it may be desirable to include conduits which pass through the side walls of the vessel and penetrate into the bed of consolidated solids and/or the settling flocculated solids. It may also be desirable for the means to include one or more apertures or conduits in the base of the vessel through which the at least one oxidising agent and only one control agent are respectively introduced. Such means may extend into the bed of consolidated solids and/or the settling flocculated solids. It may also be desirable for the means to include one or more conduits which enter through the top of the vessel, which conduits may extend into the bed of consolidated solids and/or the settling flocculated solids. Such one or more conduits may enter and run down the inner wall and base of the vessel or alternatively may be positioned such that they enter at any point from the top of the vessel. It may also be desirable for such conduits to run alongside other components used in the vessel, for example the rakes.

A particularly suitable means for introducing the at least one oxidising agent or a least one control agent is one or more rakes for conveying the agent. Suitably the one or more rakes would be hollow or otherwise comprise a conduit which allows the passage of the respective oxidising agent or control agent. We have found that this means is particularly effective at introducing the respective oxidising agent or control agent into the bed of consolidated solids. Furthermore, the action of the rakes in releasing the agent as they move throughout the bed of consolidated solids has been found to be a particularly effective way of efficiently distributing the respective oxidising agent for control agent throughout the bed of consolidated solids without adversely disturbing or re-dispersing any of the solids.

A further means by which the respective oxidising agent or control agent may be introduced into the bed of consolidated solids or settling flocculated solids includes one or more sparges. The sparges appear to allow a fine distribution of the respective oxidising agent or control agent as it is introduced into the bed of consolidated solids or the settling flocculated solids. It may also be desirable for one or more sparges to be used in conjunction with the other means of introducing the respective oxidising agent or control agent, for instance using sparges in combination with conduits which penetrate into the bed of consolidated solids or the settling flocculated solids.

In accordance with the first and third aspects of this invention the at least one oxidising agent is added into the suspension before the flocculated solid particles have settled. Thus in both aspects the oxidising agent may be added into the suspension of flocculated solids as they are settling, for instance into the feed well containing the flocculated solids. In this respect the at least one oxidising agent may be added to these settling flocculated solids at any stage prior to the solids forming a settled layer. The oxidising agent may be added simultaneously with the flocculant, during the formation of the flocculated solids or after they have formed. The oxidising agent may be added before the addition of the flocculant. However, in this case it is generally desirable that the oxidising agent is not added significantly prior to the addition of flocculant to minimise the risk of the oxidising agent being consumed or degrading before it has had an effect. For instance, the oxidising agent may be added to the suspension into the same vessel as the flocculant or it may be added into the feed line which conveys the suspension of solids. Generally speaking the oxidising agent may be added no more than 10 min prior to the addition of the flocculant. Often the oxidising agent may be added within 7 to 0 min of the addition of the flocculant, for instance between 5 and 0 min, typically less than 2 min.

In these two aspects of the invention the at least one oxidising agent can be added in to suspension using any of the aforementioned means provided that those means delivers the oxidising agent into the suspension prior to the flocculated solids forming a settled layer. Typically such means may include addition through apertures in the wall of the vessel, addition through conduits which enter through the side of the vessel, enter through the top of the vessel and/or alongside any other components of the vessel, and/or addition through sparges placed in the suspension.

In the first and third aspects of the invention the at least one oxidising agent is added at a dose below that which will impair the settling rate of the flocculated solids. This dose can easily be established through a routine test in which a sample of the suspension of solids is treated with the flocculant in the absence of the at least one oxidising agent and the time taken is recorded for the line (mud line) separating the settling solids and supernatant liquid to pass between two fixed points to provide a settling rate for instance measured in cm/min (the control test); the test would then be repeated using the same sample of the suspension of solids treated with the same flocculant at the same dose except adding the at least one oxidising agent. If the settling rate is unchanged by comparison to the control test then the dose of oxidising agent may be used. If, however, the settling rate is reduced by comparison to the control test then the test should be repeated with a lower dose of oxidising agent until the settling rate is no lower than the control test. The exact dose of oxidising agent will vary depending upon the particular oxidising agent and possibly also the type and dose of flocculant and the suspension. Nevertheless a suitable dose of at least one oxidising agent useful is in accordance with the aforementioned doses specified above.

In the first aspect of the invention the control agent contains at least one activator component as defined herein which should be added into the settled layer of solids. The activator component may be added using any of the aforementioned means provided that the activator is delivered into the settled layer of solids. For instance, the activator could be fed into the settled layer of flocculated solids contained in a vessel through apertures in the base or sidewalls of said vessel. Alternatively the activator could be fed into the settled layer through conduits which enter through the base, sidewalls, top of said vessel, or conduits which run alongside components of the vessel. In some cases it may be desirable that the activator is fed into the settled layer through sparges which enter said settled layer. In other cases it may be desirable that the activator is fed into the settled layer through rakes.

In the third aspect of the invention at least one activator component is present in the suspension but at a concentration (C2) which will not increase the activity of the oxidising agent and which is above the effective concentration or range of concentrations (C1) that would increase the activity of the oxidising agent. The concentration of activator component contained in the suspension can be determined through routine analysis. Typically such routine analysis includes conventional spectrophotometry techniques. This includes for instance atomic absorption (AA) or Induced coupled plasma atomic emission spectroscopy (ICP).

Typically activator may already have been dissolved in the water present in the suspension at high concentration. Typically the activator may have been derived from process water, for instance recycled process water used in the formation of the suspension. Alternatively the activator may have been derived from the solids component of the suspension. The activator may for example be iron (II), iron (III), iron (IV), and/or copper (II) ions present in the suspension at high concentration, for instance at above 20,000 ppm or 1%, for instance at least 2% for at least 3% for instance up to 10% or higher. In such circumstances this high concentration of activator will not activate the oxidising agent, especially in the case of ozone, peroxide, or other peroxy compounds.

In this third aspect of the invention the addition of the suppressor component should reduce the concentration of the activator to a concentration (C1) which has an activating effect on the oxidising agent. The suppressor component should be added into the settled layer of solids. The suppressor component may be added using any of the aforementioned means provided that the suppressor component is delivered into the settled layer of solids. For instance, the suppressor component could be fed into the settled layer of flocculated solids contained in a vessel through apertures in the base or sidewalls of said vessel. Alternatively the suppressor component could be fed into the settled layer through conduits which enter through the base, sidewalls, top of said vessel, or conduits which run alongside components of the vessel. In some cases it may be desirable that the suppressor component is fed into the settled layer through sparges which enter said settled layer. In other cases it may be desirable that the suppressor component is fed into the settled layer through rakes.

Suitable doses of the suppressor component will vary according to the concentration (C2) of activator component, the type and/or volume of suspension to be treated, the type of suppressor component used for the treatment. A suitable dose of suppressor component can be determined by routine experimentation. Typically such routine analysis includes conventional spectrophotometry techniques. This includes for instance atomic absorption (AA) or Induced coupled plasma atomic emission spectroscopy (ICP).

Suitable doses of suppressor component may be at least 0.1 ppm or 1 ppm. Often the dose would be at least 5 ppm and even at least 10 ppm for instance at least 20 or 30 ppm. The dose may even be greater than 50 ppm or at least 100 ppm for instance at least 500 ppm. In some cases the doses may be at least 1000 ppm or 2000 ppm for instance up to 10,000 ppm (1%) or higher. Generally the dose of suppressor may be as high as 3 or 4% or to 10% or higher.

In the fourth aspect of the present invention deactivated component is present in the suspension at a concentration (C2) which will not increase the activity of the oxidising agent and which concentration is above the effective concentration or range of concentrations that would increase the activity of the oxidising agent. In this aspect the suppressor component is added into the suspension before the flocculated solid particles have settled at a dose sufficient to reduce the concentration of the activator component to an effective concentration which will increase the activity of the oxidising agent. The suppressor component can be added in to suspension using any of the aforementioned means provided that those means delivers the suppressor component into the suspension prior to the flocculated solids forming a settled layer. Typically such means may include addition through apertures in the wall of the vessel, addition through conduits which enter through the side of the vessel, enter through the top of the vessel and/or alongside any other components of the vessel, and/or addition through sparges placed in the suspension.

In this aspect of the invention the concentration of the activator component and the effective dose of suppressor may be exactly as defined in regard to the third aspect of the invention.

In the fourth aspect of the invention the at least one oxidising agent is added into the settled layer of solids. The at least one oxidising agent should be added into the settled layer of solids. The at least one oxidising agent may be added using any of the aforementioned means provided that the oxidising agent is delivered into the settled layer of solids. For instance, the oxidising agent could be fed into the settled layer of flocculated solids contained in a vessel through apertures in the base or sidewalls of said vessel. Alternatively the oxidising agent could be fed into the settled layer through conduits which enter through the base, sidewalls, top of said vessel, or conduits which run alongside components of the vessel. In some cases it may be desirable that the oxidising agent is fed into the settled layer through sparges which enter said settled layer. In other cases it may be desirable that the oxidising agent is fed into the settled layer through rakes.

In accordance with the second aspect of this invention the at least one activator component is added into the suspension before the flocculated solid particles have settled. Thus in this aspect the activator component may be added into the suspension of flocculated solids as they are settling, for instance into the feed well containing the flocculated solids. In this respect the at least one activator component may be added to these settling flocculated solids at any stage prior to the solids forming a settled layer. The activator component may be added simultaneously with the flocculant, during the formation of the flocculated solids or after they have formed. The activator component may be added before the addition of the flocculant. For instance, the activator component may be added to the suspension into the same vessel as the flocculant or it may be added into the feed line which conveys the suspension of solids. Generally speaking the activator component may be added no more than 10 min prior to the addition of the flocculant. Often the activator component may be added within 7 to 0 min of the addition of the flocculant, for instance between 5 and 0 min, typically less than 2 min.

In this aspect of the invention the at least one activator component can be added in to suspension using any of the aforementioned means provided that those means delivers the activator component into the suspension prior to the flocculated solids forming a settled layer. Typically such means may include addition through apertures in the wall of the vessel, addition through conduits which enter through the side of the vessel, enter through the top of the vessel and/or alongside any other components of the vessel, and/or addition through sparges placed in the suspension.

In the second aspect of the invention the at least one activator component is desirably added at a dose sufficient to increase the activity of the oxidising agent. The exact dose of activator component will vary depending upon the particular activator component and also the particular oxidising agent and possibly also the type and dose of flocculant and the suspension. Nevertheless a suitable dose of at least one activator component useful is in accordance with the aforementioned doses specified above.

In the second aspect of the invention at least one oxidising agent should be added into the settled layer of solids. The oxidising agent may be added using any of the aforementioned means provided that the oxidising agent is delivered into the settled layer of solids. For instance, the oxidising agent could be fed into the settled layer of flocculated solids contained in a vessel through apertures in the base or sidewalls of said vessel. Alternatively the oxidising agent could be fed into the settled layer through conduits which enter through the base, sidewalls, top of said vessel, or conduits which run alongside components of the vessel. In some cases it may be desirable that the oxidising agent is fed into the settled layer through sparges which enter said settled layer. In other cases it may be desirable that the oxidising agent is fed into the settled layer through rakes.

By employing one or more of the control agents we have unexpectedly found that the process of concentrating the aqueous suspension of particles can be controlled more effectively. Furthermore, by using an appropriate combination of at least one oxidising agent and one or more control agents the process of concentration of the suspension can be controlled more consistently. For instance for a given solids content reduction in yield stress can be achieved more consistently. Furthermore, for a given yield stress the process enables higher solids of the concentrated suspension to be achieved more consistently. The present invention also has the advantage that in many cases less oxidising agent may tend to be required.

Therefore in one preferred form the agent system brings about a reduction in the yield stress of a layer of solids formed from the action of the organic flocculant. More preferably the layer of solids should have a yield stress at least 5% and often at least 10% and suitably at least 20% or at least 30% or even at least 50% and in some cases as much as 70, 80 or 90% or more below the yield stress of a layer of solids at an equivalent solids content without the addition of the agent system. Thus the agent system desirably brings about a reduction in the yield stress of the layer or bed of consolidated solids it enables higher solids to be achieved and an increased removal of the underflow. Preferably the reduction in yield stress will be at least 50% below the yield stress of a layer of solids at an equivalent solids content without the addition of the agent system. More preferably the reduction in yield stress will be at least 60 or 70% and often at the least 80 or 90%.

We have also found that the yield stress can be reduced below the yield stress of a layer of solids at an equivalent solids content that had not been flocculated and without the addition of the agent system. Previously there had been a generally accepted view that sedimentation of solids in the absence of flocculation would achieve the lowest yield stress. It had been generally believed that a process involving flocculation would always result in a higher yield stress than in the absence of the flocculant because the flocculant would tend to hold the sedimented solids in a structure that would tend to increase the yield stress. The method of introducing the agent system according to the present invention is particularly effective at achieving this benefit.

In a preferred form of the process the flocculated solids settle to form a bed and water is released from the suspension and in which we have found that the introduction of the agent system into the bed of consolidated solids by the means according to the present invention brings about an increase in the water released from the suspension. Consequently, we find that this increase in water released is also accompanied by an increase in the solids.

The process of the present invention has been found to enhance the concentration of a suspension, by gravity sedimentation. In this sense the rate of consolidation of separated solids is increased. In addition the fluidity or mobility of concentrated phase, i.e. settled or sedimented solids, can be significantly improved.

It has been found that the incorporation of the agent system into the flocculation process has resulted in a more rapid compaction phase, and/or reduced viscosity of the layer or bed of solids e.g. sediment at corresponding solids contents such that a higher solids content can be achieved without exceeding the maximum viscosity that the equipment carrying out the removal process can tolerate.

It is known that in general solids in suspensions will often settle without the addition of flocculant. The flocculant brings about bridging flocculation of the solids and increases the rate at which the solids settle to form a bed. Thus in conventional gravity thickening situations, improved rate of free settlement and initial compaction are achieved by the use of polymeric flocculants and optionally coagulants. In such a process the individual solid particles tend to gather together to form aggregates which have a more favorable density to surface area ratio. These aggregates can settle to form a compacted bed from which water can be further removed by upward percolation. In this way the bed progressively increases in solids content over an extensive period of time until the desired solids concentration in the bed is reached and material in the bed can be removed.

Unfortunately, in general the yield stress of the flocculated settled solids in conventional processes tends to be significantly higher than the settled solids in the absence of the flocculant. This tends to make the removal process of raking and pumping progressively more difficult. On the other hand it would not be practical to concentrate a suspension in the absence of flocculant since this would take an extremely long time, especially in a gravimetric thickener which relies upon free sedimentation.

In the process according to the invention we have found that a more rapid compaction phase can be achieved. In addition it has been found that the present process tends to result in a significantly reduced viscosity or yield stress of the layer of solids or bed as a result of treatment by the agent. In particular we find that the yield stress is not only lower than the equivalent process in the absence of the agent, but the yield stress can be as low as or lower than settled solids in the absence of the flocculant. In some cases we find that the process results in a layer or bed of solids having a yield stress significantly below that of settled solids in the absence of flocculant. This unexpected property of the settled solids facilitates the ease of removal of a solids underflow whilst at the same time ensuring rapid settling of the solids. Furthermore, it is preferred that the process is operated by allowing the solids content of the consolidated bed to increase significantly above that which can be tolerated by the equipment in the absence of the agent. In this sense the consolidated bed may still be operated at the maximum yield stress for the equipment but in which the solids content is significantly higher than the bed in a process without the agent.

The yield stress of the layer of solids including sedimented bed will vary according to the substrate. Typically the maximum yield stress of a sedimented bed that can be tolerated by conventional equipment is usually no more than 250 Pa. Within capabilities of the existing equipment it would not be possible to increase the solids using the conventional process since the yield stress would be too high. The process of the invention employing the agent has been found to reduce the yield stress by at least 5% and often at least 10% and suitably at least 20% or at least 30% or even at least 50% and in some cases as much as 70, 80 or 90% or higher. On the other hand the solids content of the layer or bed produced according to the invention can be allowed to increase by at least 1% or even at least 5% and sometimes more than 10% without exceeding the maximum yield stress that can be tolerated by the equipment. In some cases it may be possible to increase the solids by up to 15, 20, 25 or even 30% or more in comparison to a layer or bed having the same yield stress obtaining by the equivalent process but in the absence of the agent.

The actual weight percent underflow solids that can be achieved with acceptable yield stress varies considerably dependent upon the constituent and particle size of the suspended solids, and also the age and sophistication of the settling equipment. It may be as low as around 12% (typically Florida phosphate slimes) but is usually between around 20% and 50%.

The Yield Stress is measured by Brookfield R/S SST Rheometer at an ambient laboratory temperature of 25° C. using the RHEO V2.7 software program in a Controlled Shear Rate mode. Rotation of a Vane spindle (50_{—}25 vane at a 3 to 1 vessel sizing) in 120 equal step increases of 0.025 rpm generate a progressive application of increased Shear Rate.

Yield Stress is defined as the maximum shear stress before the onset of shear.

The Yield Stress is calculated by linear regression of the 4 measurement points with Shear Rate >0.1 1/s and subsequent calculation of the intercept of the axis of Tau (Pa) for Shear Rate=0.

The invention is applicable to any solids liquid separation activity in which solids are separated from a suspension by gravity sedimentation in a vessel. Particularly preferred processes involve subjecting the suspension to flocculation in a gravimetric thickener. In such a process the solids form a compacted layer of concentrated solids, which in general will be significantly higher than in the absence of the agent.

The second aqueous suspension resulting from the process may form an underflow which would normally be removed from the vessel. In many instances the second aqueous suspension forms an underflow which is then transferred to a disposal area. Alternatively the underflow may be transferred to a further processing stage, such as filtration. The further processing stage would typically be a further mineral processing stage, such as filtration or further extraction of mineral values.

As indicated previously the invention is applicable generally to solids liquid separation processes which involve gravity sedimentation in a vessel. Thus the suspension may comprise organic material including for instance sewage sludge or cellular material from fermentation processes. The suspension may also be a suspension of cellulosic material, for instance sludges from papermaking processes. Preferably the suspension is an aqueous suspension comprising mineral particles.

In a more preferred aspect of the invention the process involves the treatment of aqueous suspensions resulting from mined mineral processing and other mining wastes, for instance from carbon based industries such as coal and tar sands, comprising suspensions of mineral particles, especially clays. Thus in this preferred aspect of the process the aqueous suspension is derived from mineral or energy processing operations and/or tailings substrates. By energy processing operations we mean preferably processes in which the substrate involves the separation of materials useful as fuels.

A particularly preferred aspect of the process involves suspensions selected from mining and refining operations the group consisting of bauxite, base metals, precious metals, iron, nickel, coal, mineral sands, oil sands, china clay, diamonds and uranium.

Preferably suspended solids in the suspension should be at least 90% by weight greater than 0.5 microns. Frequently the particles in suspension will be at least 90% by weight at least 0.75 microns and preferably at least 90% by weight at least one or two microns. Typically suspended particles may have a particle size at least 90% by weight up to 2 mm and usually at least 90% by weight within the range above 0.5 microns to 2 mm. Preferably suspended particles will be at least 90% by weight up to 1 mm or more preferably at least 90% by weight up to 750 microns, especially at least 90% by weight within the range of between one or two microns and one or two millimeters.

The suspensions will often contain at least 5% by weight suspended solids particles and may contain as much as 30% or higher. Preferably suspensions will contain at least 0.25% more preferably at least 0.5%. Usually the suspensions will contain between 1% and 20% by weight suspended solids.

Suitable doses of organic polymeric flocculant range from 5 grams to 10,000 grams per tonne of material solids. Generally the appropriate dose can vary according to the particular material and material solids content. Preferred doses are in the range 10 to 3,000 grams per tonne, especially between 10 and 1000 grams per tonne, while more preferred doses are in the range of from 60 to 200 or 400 grams per tonne.

The aqueous polymer solution may be added in any suitable concentration. It may be desirable to employ a relatively concentrated solution, for instance up to 10% or more based on weight of polymer. Usually though it will be desirable to add the polymer solution at a lower concentration to minimise problems resulting from the high viscosity of the polymer solution and to facilitate distribution of the polymer throughout the suspension. The polymer solution can be added at a relatively dilute concentration, for instance as low as 0.01% by weight of polymer. Typically the polymer solution will normally be used at a concentration between 0.05 and 5% by weight of polymer. Preferably the polymer concentration will be the range 0.1% to 2 or 3%. More preferably the concentration will range from 0.25% to about 1 or 1.5%. Alternatively the organic polymeric flocculant may be added to the suspension in the form of dry particles or instead as a reverse phase emulsion or dispersion. The dry polymer particles would dissolve in the aqueous suspension and the reverse phase emulsion or dispersion should invert directly into the aqueous suspension into which the polymer would then dissolve.

The process according to the invention exhibits improved sedimentation rates. It has been found that sedimentation rate is between 2 and 30 m/hour can be achieved. In addition we find that the process enables greater than 99% by weight of the suspended solids to be removed from a suspension. In addition the process enables an increase in solids sediment concentrations of greater than 10% by weight in comparison to conventional processes operating in the absence of the agent. More preferably reduced sediment yield stress is obtaining compared to the best conventional processes.

The organic polymeric flocculant may include high molecular weight polymers that are cationic, non-ionic, anionic or amphoteric. Typically if the polymer is synthetic it should exhibit an intrinsic viscosity of at least 4 dl/g. Preferably though, the polymer will have significantly higher intrinsic viscosity. For instance the intrinsic viscosity may be as high as 25 or 30 dl/g or higher. Typically the intrinsic viscosity will be at least 7 and usually at least 10 or 12 dl/g and could be as high as 18 or 20 dl/g.

Intrinsic viscosity of polymers may be determined by preparing an aqueous solution of the polymer (0.5-1% w/w) based on the active content of the polymer. 2 g of this 0.5-1% polymer solution is diluted to 100 ml in a volumetric flask with 50 ml of 2M sodium chloride solution that is buffered to pH 7.0 (using 1.56 g sodium dihydrogen phosphate and 32.26 g disodium hydrogen phosphate per litre of deionised water) and the whole is diluted to the 100 ml mark with deionised water. The intrinsic viscosity of the polymers are measured using a Number 1 suspended level viscometer at 25° C. in 1M buffered salt solution.

Alternatively, the organic polymeric flocculant may be a natural polymer or semi natural polymer. Typical natural or semi natural polymers include polysaccharides. This will include cationic starch, anionic starch, amphoteric starch, chitosan.

One preferred class of polymers includes for instance polysaccharides such as starch, guar gum or dextran, or a semi-natural polymer such as carboxymethyl cellulose or hydroxyethyl cellulose.

One preferred class of synthetic polymers includes polyethers such as polyalkylene oxides. Typically these are polymers with alkylene oxy repeating units in the polymer backbone. Particularly suitable polyalkylene oxides include polyethylene oxides and polypropylene oxides. Generally these polymers will have a molecular weight of at least 500,000 and often at least one million. The molecular weight of the polyethers may be as high as 15 million of 20 million or higher.

Another preferred class of synthetic polymers include vinyl addition polymers. These polymers are formed from an ethylenically unsaturated water-soluble monomer or blend of monomers.

The water soluble polymer may be cationic, non-ionic, amphoteric, or anionic. The polymers may be formed from any suitable water-soluble monomers. Typically the water soluble monomers have a solubility in water of at least 5 g/100 cc at 25° C. Particularly preferred anionic polymers are formed from monomers selected from ethylenically unsaturated carboxylic acid and sulphonic acid monomers, preferably selected from (meth) acrylic acid, allyl sulphonic acid and 2-acrylamido-2-methyl propane sulphonic acid, and their salts, optionally in combination with non-ionic co-monomers, preferably selected from (meth) acrylamide, hydroxy alkyl esters of (meth) acrylic acid and N-vinyl pyrrolidone. Especially preferred polymers include the homopolymer of sodium acrylate, the homopolymer of acrylamide and the copolymer of sodium acrylate with acrylamide.

Preferred non-ionic polymers are formed from ethylenically unsaturated monomers selected from (meth) acrylamide, hydroxy alkyl esters of (meth) acrylic acid and N-vinyl pyrrolidone.

Preferred cationic polymers are formed from ethylenically unsaturated monomers selected from dimethyl amino ethyl (meth)acrylate-methyl chloride, (DMAEA.MeCl) quat, diallyl dimethyl ammonium chloride (DADMAC), trimethyl amino propyl (meth) acrylamide chloride (ATPAC) optionally in combination with non-ionic co-monomers, preferably selected from (meth) acrylamide, hydroxy alkyl esters of (meth) acrylic acid and N-vinyl pyrrolidone.

In the invention, the polymer may be formed by any suitable polymerisation process. The polymers may be prepared for instance as gel polymers by solution polymerisation, water-in-oil suspension polymerisation or by water-in-oil emulsion polymerisation. When preparing gel polymers by solution polymerisation the initiators are generally introduced into the monomer solution.

Optionally a thermal initiator system may be included. Typically a thermal initiator would include any suitable initiator compound that releases radicals at an elevated temperature, for instance azo compounds, such as azo-bis-isobutyronitrile. The temperature during polymerisation should rise to at least 70° C. but preferably below 95° C. Alternatively polymerisation may be effected by irradiation (ultra violet light, microwave energy, heat etc.) optionally also using suitable radiation initiators. Once the polymerisation is complete and the polymer gel has been allowed to cool sufficiently the gel can be processed in a standard way by first comminuting the gel into smaller pieces, drying to the substantially dehydrated polymer followed by grinding to a powder.

Such polymer gels may be prepared by suitable polymerisation techniques as described above, for instance by irradiation. The gels may be chopped to an appropriate size as required and then on application mixed with the material as partially hydrated water soluble polymer particles.

The polymers may be produced as beads by suspension polymerisation or as a water-in-oil emulsion or dispersion by water-in-oil emulsion polymerisation, for example according to a process defined by EP-A-150933, EP-A-102760 or EP-A-126528.

Alternatively the water soluble polymer may be provided as a dispersion in an aqueous medium. This may for instance be a dispersion of polymer particles of at least 20 microns in an aqueous medium containing an equilibrating agent as given in EP-A-170394. This may for example also include aqueous dispersions of polymer particles prepared by the polymerisation of aqueous monomers in the presence of an aqueous medium containing dissolved low IV polymers such as poly diallyl dimethyl ammonium chloride and optionally other dissolved materials for instance electrolyte and/or multi-hydroxy compounds e.g. polyalkylene glycols, as given in WO-A-9831749 or WO-A-9831748.

The aqueous solution of water-soluble polymer is typically obtained by dissolving the polymer in water or by diluting a more concentrated solution of the polymer. Generally solid particulate polymer, for instance in the form of powder or beads, is dispersed in water and allowed to dissolve with agitation. This may be achieved using conventional make up equipment. Desirably, the polymer solution can be prepared using the Auto Jet Wet (trademark) supplied by BASF. Alternatively, the polymer may be supplied in the form of a reverse phase emulsion or dispersion which can then be inverted into water.

The following examples illustrate the invention.

### EXAMPLE 1

### 1) Influence of Iron II (Activator Agent) on Hydrogen Peroxide (Oxidation Agent) on Flocculated China Clay Slurry

### 1.1) Control

0.9 L of 4% w/v china clay at pH 5 (natural pH of china clay with deionised water) was placed in a 1 L tall form beaker and stirred at 200 rpm using a mechanical gate stirrer.

5 mL of a dilute solution (approximately 0.05% in deionised water) of a polymer consisted of sodium acrylate/acrylamide 30/70 copolymer of approx 15,000,000 molecular weight was added and stirring continued for 30 seconds. Stirring was ceased and the flocculated material was left undisturbed for 1 minute.

After 1 minute the slurry was re-suspended by stirring continued for 30 seconds. The stirring was ceased and the time taken for the mudline to settle between the 700 mL and the 500 mL marks was recorded. Settlement rate in cm/min was calculated from this FIGURE.

### 1.2) Only H₂O₂ (Oxidant Agent) Addition

0.9 L of 4% w/v china clay at pH 5 (natural pH of china clay with deionised water) was placed in a 1 L tall form beaker and stirred at 200 rpm using a mechanical gate stirrer.

5 mL of a dilute solution (approximately 0.05% in deionised water) of a polymer consisted of sodium acrylate/acrylamide 30/70 copolymer of approx 15,000,000 molecular weight was added and stirring continued for 30 seconds. Stirring was ceased and the flocculated material was left undisturbed for 1 minute.

After 1 minute the slurry was re-suspended and 0.3 mL of 3% v/v Hydrogen Peroxide (10 ppm H₂O₂ into 0.9 L slurry) was promptly added and stirring was continued for 30 seconds. After that the stirring was ceased and the time taken for the mudline to settle between the 700 mL and the 500 mL marks was recorded. Settlement rate in cm/min was calculated from this FIGURE.

1.3) Iron(II) (Activator) and then H₂O₂ (Oxidant Agent) Addition

0.9 L of 4% w/v china clay at pH 5 (natural pH of china clay with deionised water) was placed in a 1 L tall form beaker and stirred at 200 rpm using a mechanical gate stirrer. 5 mL of a dilute solution (approximately 0.05% in deionised water) of a polymer consisted of sodium acrylate/acrylamide 30/70 copolymer of approx 15,000,000 molecular weight was added and stirring continued for 30 seconds. Stirring was ceased and the flocculated material was left undisturbed for 1 minute.

After 1 minute the slurry was re-suspended and 0.22 mL of 20% w/v copper sulphate solution (in order to obtain 10 ppm of iron(II) metal ions dissolved in the all slurry) was added and stirred for 30 seconds. At this junction a 0.30 mL of 3% v/v Hydrogen Peroxide (10 ppm H₂O₂ into 0.9 L slurry) was promptly added and stirring was continued for further 30 seconds. After that the stirring was ceased and the time taken for the mudline to settle between the 700 mL and the 500 mL marks was recorded. Settlement rate in cm/min was calculated from this FIGURE.

1.4) H₂O₂ (Oxidant Agent) and then Iron(II) (Activator) Addition
0.9 L of 4% w/v china clay at pH 5 (natural pH of china clay with deionised water) was placed in a 1 L tall form beaker and stirred at 200 rpm using a mechanical gate stirrer.

mL of a dilute solution (approximately 0.05% in deionised water) of a polymer consisted of sodium acrylate/acrylamide 30/70 copolymer of approx 15,000,000 molecular weight was added and stirring continued for 30 seconds. Stirring was ceased and the flocculated material was left undisturbed for 1 minute.

After 1 minute the slurry was re-suspended and 0.30 mL of 3% v/v Hydrogen Peroxide (10 ppm H₂O₂ into 0.9 L slurry) was added and stirred for 30 seconds. At this junction a 0.22 mL of 20% w/v copper sulphate solution (in order to obtain 10 ppm of iron(II) metal ions dissolved in the all slurry) was promptly added and stirring was continued for further 30 seconds. After that the stirring was ceased and the time taken for the mudline to settle between the 700 mL and the 500 mL marks was recorded. Settlement rate in cm/min was calculated from this FIGURE.

| | | Settlement Rate |
|---|---|---|
| Exp. Nr. | Description | (cm/min) |
| 1.1 | Control (only Flocculant) | 28.94 |
| 1.2 | 10 ppm H₂O₂ (No Activator) | 27.44 |
| 1.3 | 1) 10 ppm Fe(II). 2) 10 ppm H₂O₂ | 1.17 |
| 1.4 | 1) 10 ppm H₂O₂. 2) 10 ppm Fe(II) | 1.12 |

### EXAMPLE 2

### 2) Influence of Copper II (Activator Agent) on Hydrogen Peroxide (Oxidation Agent) on Flocculated China Clay Slurry

2.1) Control 1 (without Activator)
0.9 L of 4% w/v china clay at pH 11.5 (basified by the addition of calcium hydroxide) was placed in a 1 L tall form beaker and stirred at 200 rpm using a mechanical gate stirrer.

8 mL of a dilute solution (approximately 0.05% in deionised water) of a polymer consisted of 2-acrylamido-2-methylpropane sulfonic acid sodium acrylate/acrylamide 30/70 copolymer was added and stirring continued for 30 seconds. Stirring was ceased and the flocculated material was left undisturbed for 1 hour.

After this time the slurry was re-suspended by stirring continued for 30 seconds. The stirring was ceased and the time taken for the mudline to settle between the 700 mL and the 500 mL marks was recorded. Settlement rate in cm/min was calculated from this FIGURE.

2.2) Control 2 (with Activator)

226 mg of copper sulphate anhydrous (CuSO₄) is added into 0.9 L of 4% w/v china clay at pH 11.5 (basified by the addition of calcium hydroxide) in order to obtain 100 ppm of copper(II) metal ions dissolved in the all slurry. The contents were placed in a 1 L tall form beaker and stirred at 200 rpm using a mechanical gate stirrer.

18 mL of a dilute solution (approximately 0.05% in deionised water) of a polymer consisted of 2-acrylamido-2-methylpropane sulfonic acid sodium acrylate/acrylamide 30/70 copolymer was added and stirring continued for 30 seconds. Stirring was ceased and the flocculated material was left undisturbed for 1 hour.

After this time the slurry was re-suspended by stirring continued for 30 seconds. The stirring was ceased and the time taken for the mudline to settle between the 700 mL and the 500 mL marks was recorded. Settlement rate in cm/min was calculated from this FIGURE.

### 2.3) Only H₂O₂ (Oxidant Agent) Addition

0.9 L of 4% w/v china clay at pH 11.5 (basified by the addition of calcium hydroxide) was placed in a 1 L tall form beaker and stirred at 200 rpm using a mechanical gate stirrer.

Under stirring, 3 mL of 3% v/v Hydrogen Peroxide solution (100 ppm H₂O₂ into 0.9 L slurry) is added into the mixed slurry followed by the addition of 8 mL of a dilute solution (approximately 0.05% in deionised water) of a polymer consisted of 2-acrylamido-2-methylpropane sulfonic acid sodium acrylate/acrylamide 30/70 copolymer. The contents were continuous stirred for 30 seconds. Stirring was ceased and the flocculated material was left undisturbed for 1 hour.

After this time the slurry was re-suspended by stirring continued for 30 seconds. The stirring was ceased and the time taken for the mudline to settle between the 700 mL and the 500 mL marks was recorded. Settlement rate in cm/min was calculated from this FIGURE.

### 2.4) Copper(II) (Activator) and H₂O₂ (Oxidant Agent) Additions

226 mg of copper sulphate anhydrous (CuSat) is added into 0.9 L of 4% w/v china clay at pH 11.5 (basified by the addition of calcium hydroxide) in order to obtain 100 ppm of copper(II) metal ions dissolved in the all slurry. The contents were placed in a 1 L tall form beaker and stirred at 200 rpm using a mechanical gate stirrer.

Under stirring, 3 mL of 3% v/v Hydrogen Peroxide solution (100 ppm H₂O₂ into 0.9 L slurry) is added into the mixed slurry followed by the addition of 18 mL of a dilute solution (approximately 0.05% in deionised water) of a polymer consisted of 2-acrylamido-2-methylpropane sulfonic acid sodium acrylate/acrylamide 30/70 copolymer. The contents were continuous stirred for 30 seconds. Stirring was ceased and the flocculated material was left undisturbed for 1 hour.

After this time the slurry was re-suspended by stirring continued for 30 seconds. The stirring was ceased and the time taken for the mudline to settle between the 700 mL and the 500 mL marks was recorded. Settlement rate in cm/min was calculated from this FIGURE.

| | | Settlement Rate |
|---|---|---|
| Exp. Nr. | Description | (cm/min) |
| 2.1 | Control 1 (Only Flocculant - No Activator) | 16.20 |
| 2.2 | Control 2 (Only Flocculant - With Activator) | 15.73 |
| 2.3 | 100 ppm H₂O₂ (No Activator) | 11.89 |
| 2.4 | 1) 100 ppm Cu(II). 2) 100 ppm H₂O₂ | 3.56 |

1. A process of concentrating a suspension of solid particles in an aqueous medium, the process comprising:
introducing into the suspension at least one organic polymeric flocculant and an agent system,
flocculating the solid particles in the suspension by action of the at least one organic polymeric flocculant to form flocculated solid particles, and
settling the flocculated solid particles to form a settled layer of solids in the aqueous medium,
wherein
the agent system comprises:
one an oxidising agent, and
a control agent consisting of at least one activator component and/or at least one suppressor component,
the at least one activator component increases activity of the oxidising agent, and
the at least one suppressor component decreases concentration of the at least one activator component,
wherein
1) the oxidising agent is added to the suspension before said settling at a dose below that which will impair settling rate and the at least one activator component is added into the settled layer of solids; or
2) the activator component is added to the suspension before said settling and the oxidising agent is added into the settled layer of solids; or
3) the oxidising agent is added to the suspension before said settling at a dose below that which will impair settling rate; the at least one activator component is present in the suspension at a concentration (C2) which will not increase the activity of the oxidising agent and which is above an effective concentration or a range of concentrations (C1) that will increase the activity of the oxidising agent; and the at least one suppressor component is added into the settled layer of solids at a dose sufficient to reduce concentration of the at least one activator component to the effective concentration or within the range of concentrations (C1); or
4) the at least one activator component is present in the suspension at a concentration (C2) which will not increase the activity of the oxidising agent and which is above the effective concentration or the range of concentrations (C1) that will increase the activity of the oxidising agent; the at least one suppressor component is added to the suspension before said settling at a dose sufficient to reduce the concentration of the at least one activator component to the effective concentration or within the range of concentrations (C1); and the oxidising agent is added into the settled layer of solids.

2. The process according to claim 1, wherein the oxidising agent is selected from the group consisting of a perchlorite, a hypochlorate, a perbromate, a hypobromite, a periodate, a hypoiodite, a perborate, a percarbonate, a persulphate, a peracetate, ozone and a peroxide.

3. The process according to claim 1, wherein the oxidising agent is ozone water or hydrogen peroxide.

4. The process according to claim 1, wherein the at least one activator component is selected from the group consisting of an iron (II) ion (Fe2+), an iron (III) ion (Fe3+), an iron (IV) ion (Fe4+) and a copper (II) ion (Cu2+).

5. The process according to claim 1, wherein the at least one suppressor component is selected from the group consisting of:
a radical quencher;
a sequestering agent; and
a metal salt that promotes formation of side and deactivated species.

6. The process according to claim 1, wherein the respective doses of the oxidising agent and the control agent added are chosen to provide desired reduction in yield stress of layer of solids suspended in the aqueous medium for a desired solids content.

7. The process according to claim 1, wherein the respective doses of the oxidising agent and the control agent added are chosen to provide desired increase in solids content of layer of solids suspended in the aqueous medium for a desired yield stress.

8. The process according to claim 1, wherein the process is a sedimentation process carried out in a sedimentation vessel.

9. The process according to claim 8, wherein the vessel comprises a feedwell in which suspension of the flocculated solid particles is formed and within which the flocculated solid particles start to settle.

10. The process according to claim 9, wherein the oxidising agent or the control agent are introduced into the flocculated solid particles that are settling in the feedwell.

11. The process according to claim 1, further comprising: transferring layer of solids suspended in the aqueous medium that forms an underflow either to a disposal area or to a mineral processing operation.

12. The process according to claim 1, wherein the suspension of solid particles comprises mineral particles.

13. The process according to claim 1, wherein the suspension of solid particles is derived from mineral or energy processing operations and/or tailings substrates and is selected from the group consisting of bauxite, a base metal, a precious metal, an iron comprising solid, a nickel comprising solid, a coal tailing, a mineral sand, an oil sand, china clay, diamond and a uranium comprising solid.

14. The process according to claim 1, wherein the at least one organic polymeric flocculant is a non-ionic or anionic polymer that is either a synthetic, of intrinsic viscosity of at least 4 dl/g or a natural polymer.

15. The process according to claim 1, wherein the at least one organic polymeric flocculant is selected from the group consisting of a homopolymer of sodium acrylate, a homopolymer of acrylamide and copolymers a copolymer of acrylamide and sodium acrylate.
